(19) United States
(12) Patent Application Publication
(10) Pub. No.: US 2015/0178887 A1
(43) Pub. Date: Jun. 25, 2015

(54) DISPLAY CONTROL APPARATUS AND CONTROL METHOD FOR VEHICLE

(71) Applicant: Hyundai Motor Company, Seoul (KR)

(72) Inventors: Tae Yub KIM, Jinju-Si (KR); Ho Taek LEE, Seoul (KR); Hee Jin RO, Seoul (KR); Jong Yong NAM, Seongnam-Si (KR); Jong Bok LEE, Yongin-Si (KR); Yong LEE, Suwon-Si (KR); In Seong PARK, Seoul (KR)

(21) Appl. No.: 14/472,237

(22) Filed: Aug. 28, 2014

(30) Foreign Application Priority Data
Dec. 19, 2013 (KR) 10-2013-0159593

(51) Int. Cl. G06T 3/20

(52) U.S. Cl. CPC G06T 3/20

(57) ABSTRACT

A display control apparatus of a vehicle for controlling a graphical user interface on a screen of a display apparatus which is mounted to a vehicle is provided. The display control apparatus includes a time information detector configured to detect time information for determining the height of the sun. A driving information detector is configured to detect driving information for determining a driving direction of the vehicle. A controller is configured to receive the time information from the time information detector and the driving information detected from the driving information detector so as to reposition a graphical user interface area where the graphical user interface is displayed on the screen. The graphical user interface area may be repositioned so as to escape from a reflection area where sunlight is reflected by the screen.

### CROSS-REFERENCE TO RELATED APPLICATION

This application claims the benefit of priority to Korean Patent Application No. 10-2013-0159593 filed in the Korean Intellectual Property Office on Dec. 19, 2013, the entire contents of which are incorporated herein by reference.

### TECHNICAL FIELD

The present disclosure relates to a display control apparatus and a display control method for a vehicle. More particularly, the present disclosure relates to a display control apparatus and a display control method for a vehicle which is adapted to avoid reflection of light and ensure visibility.

### BACKGROUND

Generally, a display apparatus for a vehicle is used for transmitting various information on navigation, driving conditions, parking, and so on.

Recently, a screen area of the display apparatus provided for a vehicle has become wider to ensure driver's visibility. However, the visibility may be deteriorated when light is reflected by a wide screen. In other words, an area reflecting light may become wider in proportion to the area of the screen.

Light of the sun, street lights, head lights of other vehicles, and so on may be external light which is reflected by the screen. Particularly, the driver's visibility when the light of the sun is reflected by the screen may be noticeably deteriorated in correspondence with other external light reflected by the screen.

The light reflection generated by the screen must be prevented because the light reflection is a cause of deteriorating driving safety.

An anti-reflection film may be attached to the screen so as to prevent the light reflection, but the anti-reflection film may increase the manufacturing cost of a display apparatus and simultaneously worsen image quality of the screen.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a display control apparatus and a display control method for a vehicle having advantages of effectively avoiding external light reflection from a screen.

According to an exemplary embodiment of the present invention, a display control apparatus of a vehicle for controlling a graphical user interface on a screen of a display apparatus, which is mounted to a vehicle, is provided. The display control apparatus may include a time information detector configured to detect time information for determining the height of the sun. A driving information detector is configured to detect driving information for determining a driving direction of a vehicle. A controller is configured to receive the time information from the time information detector and the driving information detected from the driving information detector to reposition a graphical user interface area where the graphical user interface is displayed on the screen. The graphical user interface area may be repositioned to escape from a reflection area where sunlight is reflected by the screen.

The controller may predict the reflection area according to the time information and the driving information transmitted from the time information detector and the driving information detector.

The graphical user interface area may move to escape from the reflection area.

The graphical user interface area may be reduced to escape from the reflection area.

According to an exemplary embodiment of the present invention, a display control method for controlling a graphical user interface on a screen of a display apparatus, which is mounted to a vehicle, is provided. The method may include detecting time information for determining the height of the sun. Driving information for determining a driving direction of the vehicle is detected. A reflection area where sunlight is reflected on the screen is predicted based on the time information and the driving information. Whether or not the reflection of the sunlight is generated on the screen is determined by predicting the reflection area. A graphical user interface area is repositioned such that the graphical user interface is displayed on the screen to escape from the reflection area if the reflection of the sunlight is generated on the screen.

The time information and the driving information may be detected again if the reflection of the sunlight is not generated on the screen.

The time information may be detected simultaneously with detecting the driving information.

The method may start when the display apparatus is turned on.

The method may end if the graphical user interface area is repositioned, and may restart if the height of the sun or the driving direction of the vehicle is changed by at least a set value.

### BRIEF DESCRIPTION OF THE DRAWINGS

FIG. 1 is a schematic diagram of a display apparatus according to an exemplary embodiment of the present disclosure.

FIG. 2 is a schematic diagram of a display apparatus according to another exemplary embodiment of the present disclosure.

FIG. 3 is a block diagram of a display control apparatus according to an exemplary embodiment of the present disclosure.

FIG. 4 is a flowchart of a display control method according to an exemplary embodiment of the present disclosure.

### DETAILED DESCRIPTION OF THE EMBODIMENTS

An exemplary embodiment of the present disclosure will hereinafter be described in detail with reference to the accompanying drawings.

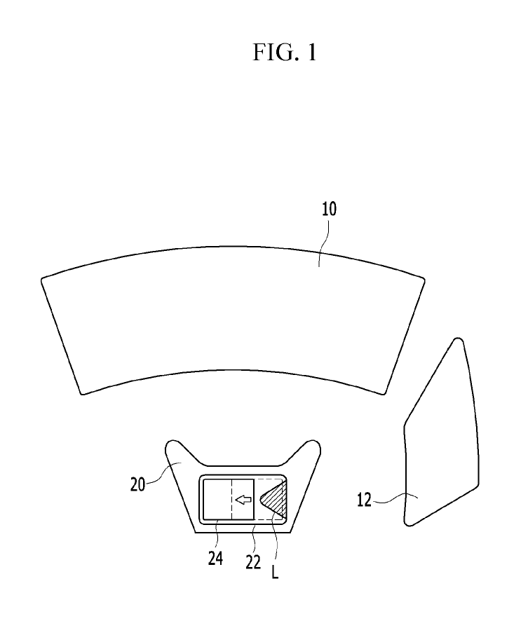

FIG. 1 is a schematic diagram of a display apparatus according to an exemplary embodiment of the present disclosure.

As shown in FIG. 1, a display apparatus 20 according to an exemplary embodiment of the present disclosure includes a screen 22. In addition, FIG. 1 schematically shows a position of a display apparatus interior of a vehicle.

The screen 22 is a monitor which displays an image transmitting to a user. Further, the screen 22 has a graphical user interface (GUI) area 24. The graphical user interface area 24 is an area where a GUI is provided on the screen 22.

The screen 22 and the GUI are well-known to a person of ordinary skill in the art, so a detailed description thereof will be omitted.

The display apparatus 20 is mounted to an instrument panel, and is exposed to external light penetrated inside a vehicle through a windshield glass 10 and a door glass 12. In addition, the more the screen 22 of the display apparatus 20 slants to be close to horizontal, the more the screen 22 is exposed to the external light penetrated through the windshield glass 10, and the more the screen 22 slants to be close to vertical, the more the screen 22 is exposed to the external light penetrated through the door glass 12. Further, the screen 22 of the display apparatus 20 is more exposed to the external light penetrated through a door glass 12 which is disposed to a front passenger seat side with apparatuses protruding from a dashboard to correspond with the external light penetrated through a door glass 12 which is disposed to a driver's seat side where various apparatuses, such as a steering apparatus, are protruding further from the dashboard than the display apparatus 20.

Particularly, a technique to prevent user's visibility from being deteriorated by sunlight reflected by the screen 22 of the external light will be described in an exemplary embodiment of the present disclosure.

In the specification, a reflection area L will be defined as a portion of the screen 22 where the sunlight is reflected. The graphical user interface area 24 can move on the screen 22 so as to escape from the reflection area L if the light is reflected by the screen 22. Although FIG. 1 illustrates that the graphical user interface area 24 moves from an area represented by a dotted line to an area represented by a solid line along an arrow direction on the screen 22, it is not limited thereto. For example, the graphical user interface area 24 may become the entire screen 22, or be reduced so as to avoid the reflection area L.

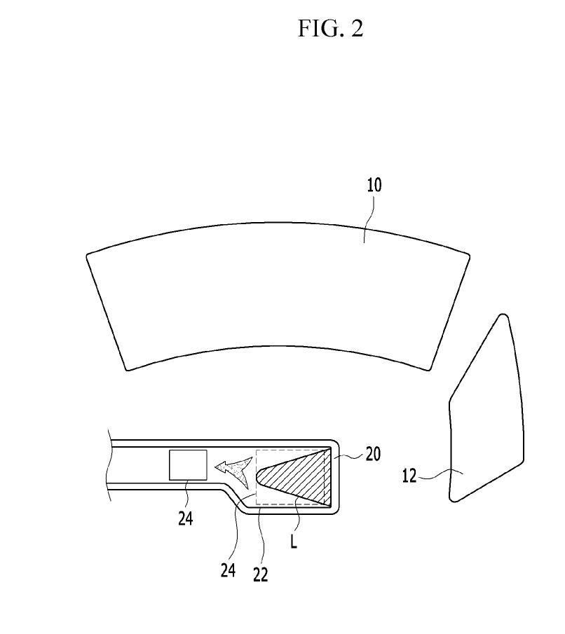

FIG. 2 is a schematic diagram of a display apparatus according to another exemplary embodiment of the present disclosure.

FIG. 2 shows a case in which the screen 22 is extended to a portion where an instrument cluster is disposed on the instrument panel. That is, a length and a range of the screen 22 are expanded such that the display apparatus 20 extends from a center portion of the instrument panel to a driver driver's front view. In this case, the graphical user interface area 24 can easily avoid the reflection area L where the sunlight is reflected by the screen 22.

The graphical user interface area 24 may become the entire screen 22 or reduced so as to be positioned in a center portion of the instrument panel. In addition, the graphical user interface area 24 freely and selectively moves from the center portion of the instrument panel to the driver's front view so as to avoid the reflection area L. Further, the graphical user interface area 24 is reduced by a predetermined value by considering interference with other display subjects by a person of ordinary skill in the art in a case that the graphical user interface area 24 moves to the instrument cluster disposed in front of the driver. In FIG. 2, the graphical user interface area 24 disposed at the center portion being moved to the portion where the instrument cluster is disposed is represented by an arrow.

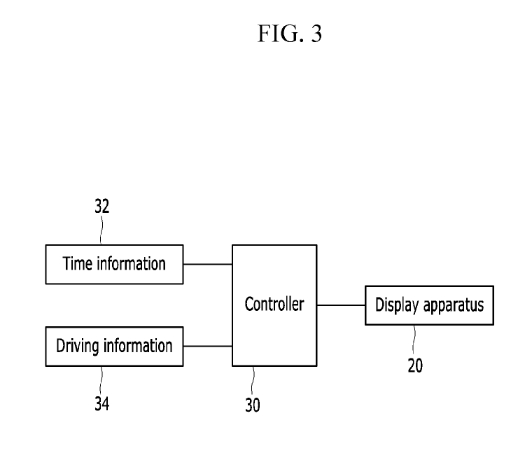

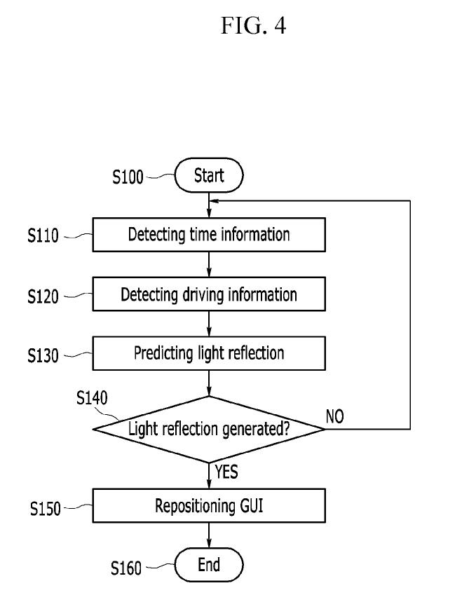

Referring to FIGS. 3 and 4, a display control in which the graphical user interface area 24 avoids the sunlight penetrating to the screen 22 will be described in detail.

FIG. 3 is a block diagram of a display control apparatus according to an exemplary embodiment of the present disclosure.

As shown in FIG. 3, a display control apparatus according to an exemplary embodiment of the present disclosure includes a controller 30, a time information detector 32, and a driving information detector 34.

The controller 30 receives time information and driving information so as to control the display apparatus 20. That is, the controller 30 predicts the reflection area L on the screen 22 according to the time information and the driving information, and moves or reduces the graphical user interface area 24 on the screen 22.

The time information is for determining the height of the sun. For instance, direct rays of the sun penetrate to the interior of a vehicle through the windshield glass 10 in a time zone at which the height of the sun is relatively high, and direct rays of the sun penetrate to the interior of the vehicle through the door glass 12 in a time zone at which the height of the sun is relatively low. Therefore, the controller 30 can predict a route of the sunlight by determining the height of the sun according to the time information.

The driving information is for determining a driving direction of the vehicle. For instance, the route of the sunlight penetrating inside the vehicle may greatly vary according to the driving direction in the time zone in which the height of the sun is relatively low. Particularly, the direct rays of the sun may penetrate to the interior of the vehicle through the door glass 12 disposed to the side of the front passenger seat in a case in which the vehicle is driven toward the north at dawn, or when the vehicle is driven toward the south at sunset. Thus, predicting the route of the sunlight can become relatively accurate if the controller 30 predicts the route of the sunlight penetrating inside the vehicle by using the time information and the driving information together.

The time information detector 32 detects the time information and transmits the detected time information to the controller 30.

The driving information detector 34 detects the driving information and transmits the detected driving information to the controller 30.

Detecting the time information and the driving information is performed based on a GPS signal and so on, and the method for detecting the time information and the driving information is well-known to a person of ordinary skill in the art, so a detailed description thereof will be omitted. That is, detecting the time information and the driving information may be performed without additional constituent elements or technical elements in an existing vehicle. Therefore, an additional cost for detecting the time information and the driving information may not be required.

FIG. 4 is a flowchart of a display control method according to an exemplary embodiment of the present disclosure.

As shown in FIG. 4, controlling display apparatus 20 according to an exemplary embodiment of the present disclosure starts at step S100, and then the time information detector 32 detects the time information at step S110. Herein, the display apparatus 20 may start as the display apparatus 20 is ON.

The driving information detector 34 detects the driving information at step S120 if the time information is detected. Herein, detecting the time information at step S110 and detecting the driving information at step S120 may be simultaneously performed.

The controller 30 predicts the reflection of the sunlight that is emitted and reflected on the screen 22 at step S130 if the detected time information and driving information are transmitted from the time information detector 32 and the driving information detector 34 to the controller 30. Herein, predicting the reflection of the light means that the reflection area L is predicted by predicting a route of the sunlight which penetrates to the interior of the vehicle.

The controller 30 determines whether the reflection of the sunlight is generated on the screen 22 at step S140 by predicting the light reflection.

If it is determined that the reflection from the sunlight that is emitted and reflected on the screen 22 is not generated, the above mentioned steps are repeated from detecting the time information at step S110 and detecting the driving information at step S120.

If it is determined that the reflection of the sunlight that is emitted and reflected on the screen 22 is generated, the controller 30 repositions the graphical user interface area 24 on the screen 22 at step S150. Herein, the step of repositioning the graphical user interface area 24 is moving or reducing the graphical user interface area 24.

If the graphical user interface area 24 is repositioned, controlling the display apparatus 20 ends at step S160.

At this time, the controlling of the display apparatus 20 restarts at step S100 when a driving direction or a time zone is changed by at least a set value. It is variously realized by design of a person of ordinary skill in the art that controlling the display apparatus 20 restarts according to the change in the driving direction or the time zone with reference to the set value regarding the driving direction and the time zone.

According to an exemplary embodiment of the present disclosure, the GUI area 24 is repositioned so as to avoid the light reflecting on the screen 22 such that the driver's visibility can be ensured and driving safety can be secured.

In addition, elements, such as an anti-reflection film, are not required such that image quality of the screen 22, which may be deteriorated by the anti-reflection film, can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display control apparatus of a vehicle for controlling a graphical user interface on a screen of a display apparatus which is mounted to a vehicle, the display control apparatus comprising:
a time information detector configured to detect time information for determining the height of the sun;
a driving information detector configured to detect driving information for determining a driving direction of a vehicle; and
a controller configured to receive the time information from the time information detector and the driving information detected from the driving information detector to reposition a graphical user interface area where the graphical user interface is displayed on the screen,
wherein the graphical user interface area is repositioned to escape from a reflection area where sunlight is reflected on the screen.

2. The apparatus of claim 1, wherein the controller predicts the reflection area according to the time information and the driving information transmitted from the time information detector and the driving information detector.

3. The apparatus of claim 1, wherein the graphical user interface area is repositioned to escape from the reflection area.

4. The apparatus of claim 1, wherein the graphical user interface area is reduced to escape from the reflection area.

5. A display control method for controlling a graphical user interface on a screen of a display apparatus which is mounted to a vehicle, the method comprising steps of:
detecting time information for determining the height of the sun;
detecting driving information for determining a driving direction of the vehicle;
predicting a reflection area where sunlight is reflected by the screen based on the time information and the driving information;
determining, by predicting the reflection area, whether the reflection of the sunlight is generated on the screen or not; and
repositioning a graphical user interface area such that the graphical user interface is displayed on the screen to escape from the reflection area if the reflection of the sunlight is generated on the screen.

6. The method of claim 5, wherein the steps of detecting the time information and the driving information is performed again if the reflection of the sunlight is not generated on the screen.

7. The method of claim 5, wherein the step of detecting the time information is simultaneously performed with the step of detecting the driving information.

8. The method of claim 5, wherein the method starts when the display apparatus is turned on.

9. The method of claim 5, wherein the method ends if the graphical user interface area is repositioned and restarts if the height of the sun or the driving direction of the vehicle is changed by at least a set value.
